(19) United States
(12) Patent Application Publication
(10) Pub. No.: US 2025/0245764 A1
(43) Pub. Date: Jul. 31, 2025

(54) SYSTEM AND METHOD OF MEASURING ORIGINAL CONTENT FROM COMPUTERS

(71) Applicants: Joshua Marks, McGregor, TX (US); BAYLOR UNIVERSITY, Waco, TX (US)

(72) Inventors: Robert J. Marks, II, Waco, TX (US); Joshua Marks, McGregor, TX (US); Jonathan Edwin Swindell, Waco, TX (US)

(73) Assignee: BAYLOR UNIVERSITY, Waco, TX (US)

(21) Appl. No.: 19/040,509

(22) Filed: Jan. 29, 2025

Related U.S. Application Data
(60) Provisional application No. 63/626,774, filed on Jan. 30, 2024.

(51) Int. Cl. G06Q 50/20; G06F 16/335; G06F 16/38

(52) U.S. Cl. CPC G06Q 50/205; G06F 16/337; G06F 16/38

(57) ABSTRACT

The disclosure provides a system and method to measure the degree to which a document has been originated by an author, generally by measuring how the data was generated. The system can generate a record, such as a metadocument, that records multiple actions of the author to use as factors in the analysis such as keystroke movements, mouse movements, touch screen input, video access and use, and other data recorded during the creation of the document. The metadocument can be examined to assess the degree to which the document was author generated and to what degree external documents were used. The metadocument can accompany a document submission to an examiner for independent review. Output may include a certificate of authenticity or other report that may be external to the document, on the document such as a watermark, or embedded in the document properties for the life of the document.

### CROSS REFERENCE TO RELATED APPLICATIONS

This application claims benefit of and priority to U.S. Provisional patent application 63/626,774, filed Jan. 30, 2024, which is hereby incorporated by reference for all purposes as if set forth herein in its entirety.

### STATEMENT REGARDING FEDERALLY SPONSORED RESEARCH OR DEVELOPMENT

Not applicable

### REFERENCE TO APPENDIX

Not applicable

### BACKGROUND OF THE INVENTION

### Field of the Invention

The disclosure generally relates to detecting use of original and non-original content by authors of computer documents. More specifically, the disclosure relates to detecting use of artificial intelligence and other sources of non-original content by authors in computer documents.

### Description of the Related Art

Artificial intelligence tools can be used by students to draft answers to questions, and it is difficult to detect when students have engaged in such actions.

### BRIEF SUMMARY OF THE INVENTION

The disclosure provides a system and method to measure the degree to which a document has been originated by an author, generally by measuring how the data was generated. The system can generate a record, such as a metadocument, that records multiple actions of the author during the drafting of a document, to use as factors in the analysis of whether the author obtained content from an artificial intelligence source, such as keystroke movements, mouse movements, touch screen input, video access and use, and other data recorded during the creation of the document. The metadocument can be examined to assess the degree to which the document was author generated and to what degree external documents or content was used and added to the document, such as by copying large blocks of text. The metadocument can accompany a document submission to an analysis system to generate objective metrics to facilitate independent review. The output can include a certificate of authenticity or other report that may be external to the document, on the document such as a watermark, embedded in the document properties for the life of the document, or included in other suitable manners.

The disclosure provides a method of determining original content in a document, comprising monitoring actions of an author in creating the document, the monitoring being concurrent with the actions. The actions are recorded to establish a record, and the record is analyzed to determine actions that are inconsistent with acceptable performance of such actions in creating the document to establish an analysis. A report is generated based on the analysis for use in certifying the authenticity of the document.

The disclosure further provides a system of determining original content in a document, comprising an input device configured to monitor actions of an author creating a document. A processer is configured to monitor the actions taken by the author while creating the document, where the monitoring is concurrent with the actions. The actions are recorded to establish a record, and the record is analyzed to determine actions that are inconsistent with acceptable performance of such actions in creating the document to establish an analysis. An output is generated that is configured to provide a report, based on the analysis.

### BRIEF DESCRIPTION OF THE SEVERAL VIEWS OF THE DRAWINGS

FIG. 1 is a diagram of a system for measuring original content from computers, in accordance with an example embodiment of the present disclosure;

FIG. 2 is a diagram of a process for generating metrics for assessing original content from computers, in accordance with an example embodiment of the present disclosure;

FIG. 3 is a diagram of a process for generating a confidence metric, in accordance with an example embodiment of the present disclosure; and

FIG. 4 is a diagram of an algorithm for analyzing a document to generate a confidence estimate, in accordance with an example embodiment of the present disclosure.

### DETAILED DESCRIPTION

The Figures described above, and the written description of specific aspects and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of any embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a controller would encompass a processor and a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. The term “computer” is used broadly and can include any electronic processor upon which an author can provide input. The term “document” is used broadly and can include any artifact that can accept author input and be saved and sent to others in some form. The term “author” is used broadly and can include writers, recording artists, designers, and others that can at least partially create a document. The term “mouse” is used broadly and can include a trackpad also known as a touchpad or glide pad.

Generative artificial intelligence (AI) uses large quantities of training data of a specified type to generate similar objects of that type. Text generation software such as performed by ChatGPT is trained with copious amounts of human generated text to generate text in response to a prompt. This type of AI is a subset of AI and is referred to as a large language model (LLM). Image generative AI, such as Midjourney and Dall-E, are trained with images. ThisPersonDoesNotExist.com, for example, is trained with images of real people. GitHub's Copilot, trained on computer code, generates computer code. Generative AI like GPT4V can describe images in text or, given images, generate image descriptions.

Conventional plagiarism tools check submitted work to available prose on the web. This technique is ineffective for LLMs like ChatGPT because the generated prose does not copy verbatim from existing web sites. LLM detectors are sought by educational institutions seeking identification of students who copy from LLMs. There are known tools that purport to detect use of LLMs, but these attempt detection by examining prose alone. Further, performance claims of existing LLM detectors by their originators seem to be exaggerated. One LLM offered by a known AI originator has removed access to its detector because of inaccuracies. Another known detector has reported 20% false alarms, meaning that one fifth of the authors, such as students, would be charged with using an LLM even though they did not. Still further, even if a conventional LLM detector has a high-performance rating, there are numerous “cheats” available to authors. The author can alter the LLM generated content to fool the detector.

Some recent efforts have focused on attaching authors certifying or signing the authenticity of their documents. One example is Content Authenticity Initiative (CAI). On the CAI website at https://contentauthenticity.org/faq, it answers the question of “Will the CAI solve all misinformation problems?” by stating: No—there are generally three ways to address misinformation: education, detection, and attribution. The CAI is creating an attribution-focused solution.” It emphasizes attribution to various content in a document to be entered into metadata of the document as a method of transparency to the public. Once entered the information can be encrypted. However, this initiative depends on the care and accuracy of the author to cause such attribution.

A second example is Project Origin. On the Origin website at https://www.originproject.info/about, it describes the issue to be solved by Origin as follows, “In short, people need to know what they're seeing is content that was actually produced by its purported source.” Further, “[a]ltered or synthetic material can at times appear to come from reputable journalistic entities can make false or misleading material look credible.” Origen seeks to provide: “Digitally signed links that provide verifiable tracing back of media content to the publisher.” and “Validation checks that the material was not changed during distribution.” Again, this initiative depends on the care and accuracy of the original publisher of the content for digitally signed links.

Thus, there remains a need for a system and method of an LLM detector with improved accuracy from a different approach than currently available.

The disclosure provides a system and method to measure the degree to which a document has been originated by an author, generally by measuring how the data was generated. The system can generate a record, such as a metadocument, that records multiple actions of the author to use as factors in the analysis such as keystroke movements, mouse movements, touch screen input, video access and use, and other data recorded during the creation of the document. The metadocument can be examined to assess the degree to which the document was author generated and to what degree external documents were used. The metadocument can accompany a document submission to an examiner for independent review. Output may include a certificate of authenticity or other report that may be external to the document, on the document such as a watermark, or embedded in the document properties for the life of the document.

In one example embodiment, an author can prepare a document with one or more of text, graphics, embedded sounds, and other aspects of a document. While producing such aspects, a recording software, such as an processor application, can monitor the author's actions on the computer. These actions can include one or more of the following actions by the author: keystroke timing of pressing and release, keystroke cycling to a next keystroke, keystroke errors, keystroke corrections, and other keystroke related metrics; mouse clicking, mouse movement; accessing external material; touch screen input; copying external material; accessing preexisting audio screen data including screen shots and/or video either stored or external from the Internet, accessing preexisting listened-to data either stored or external from the Internet; playing preexisting audio; playing captured video such as from a video camera connected to the computer, playing captured audio data such as from a microphone connected to the computer, speaking audio that can be translated into text, speaking audio that can be used to establish a speaker's identity. Key stroke timing can include measuring a time for pressing the key and a time for releasing the key with the difference being the keystroke time and a time of the following keystroke being a keystroke pacing. Mouse clicking and movement can include click location, click data, and mouse button pressing and releasing. Captured video and audio can be video and audio recorded during a document creation.

The information on the author's actions during the document creation can be monitored and recorded by the recording software to create a record such as a metadocument in a form electronically, hard copy, otherwise. The metadocument generated by recording software contains the history of the computer actions of the author taken during the creation of the document. The contents of the metadocument can vary to include one or more of the measured factors. For example, the metadocument contents can be limited to data generated within the confines of data collected within the single document in a single application, such as a word processing software. Another example of metadocument contents can include data collected from some or all resident software or web-based internet applications accessed during the creation of the document such as other word processing documents, locally resident applications, applications and resources on the internet, received emails, and other sources. Another category for metadocument contents can be collected from monitoring network packets transmitted and received from the author's computer.

When the document is completed in a form that the author is ready to submit and sends the document, the metadocument can be sent with the document, and can be attached to the document as a single file, or embedded in the document.

The document and metadocument can be presented to a system analysis software that that uses the metadocument to analyze the history of the document creation.

After analysis, the analysis software can generate a report indicating the measure to which the author's document was directly created by the author. The report can include such information as: document content labeling, such as for LLMs, portions of the document not generated by the author can be highlighted; listing all content accessed during generation of the document that was not directly generated by the author; and/or, generating one or more metrics computed by the analysis software. For example, the system can provide a measure of at least one of original data of the author and non-original data of the author. As other examples, the system can provide a measure, such as a percentage, of data generated directly by the author and/or provide a measure of data externally accessed during creation of the document whether such data appears in the analyzed document.

In least one embodiment, the report can be in the form of a certificate, such as a digital certificate that is separate or integrated into the document. If integrated, the certificate can form a portion of the document properties that follows the document as it is circulated in the normal course of its life. This certificate allows readers and other users of the document to rely on the authenticity of the author's creation by attesting prior to being released.

Optionally, the system can allow the author to indicate whether the author stipulated use of external material, as might be fair use. As one example, the stipulation can be done during creation of the document with the author directly informing the recording software during the creation of the document so that use is indicated in the metadocument, and/or after being informed by the analysis software, the author can retroactively identify use of external data.

An author's actions can be monitored by the recording software during the duration of a running application or for the entire time the author is using a computer. The software can be running in the background to log events generated by the author or as a consequent of the author's actions. As described above, the software can write this information to a metadocument file optionally in form of a certificate. Later, this information can be used to assess the likelihood of relevant documents having originated from an LLM.

In this example of an embodiment, logged events can include one or more of the following:
Logging key press and release events where the difference between the key release and the key press measures duration;
Logging mouse information such as click events, click locations, hover positions, where the difference between a mouse (click) release and mouse (click) press measures the duration of a mouse click;
Logging time of author's actions;
Logging processes used by author, such as active operating system process information and applications the author is interacting with during a document session; and
Other methods to collect author information such as network traffic, audio, and video streams can be recorded.

The information can be monitored and recorded in a log, combined, and sent to a file to write the data in various forms as described above and eventually the report.

The document and metadocument can be provided for analysis to analysis software. Depending on the factors that are monitored and included in the metadocument, the analysis software can determine existence of LLM material. A number of evaluation methods can be applied to assess the likelihood of LLM origin depending on the factors. Each of these assessments can be evaluated independently and a final overall score generated. The methods can be used for a generic user. Further, the process can be used repetitively with a specific author to build a data file to predict future efforts of that author with greater accuracy.

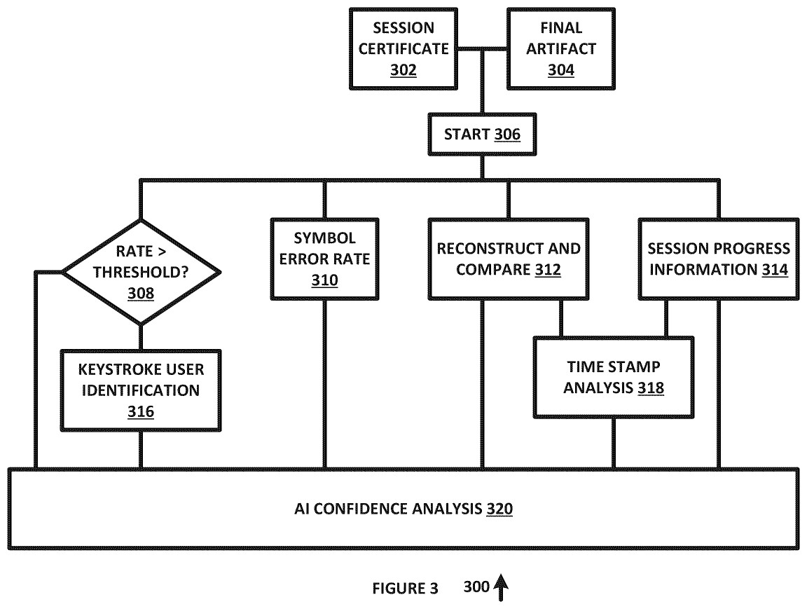

A measured factor of keystroke usage is analyzed, with the understanding that other factors could be used. Further, various factors can be used in conjunction other factors for a composite analysis. In FIG. 3, the analysis process can review the keystroke timing, error rate from the keystrokes, and other information gained from the keystrokes.

For a nonlimiting example, the metadocument data can be analyzed as follows:
If the typed character rate is above the speed of thought, then some automation was used.
As the author types, the author will make errors and correct them. The number and rate of these errors can be used to assess the authenticity of the document and if a model learns the tendencies of an author, the analysis of LLM material can be applied with greater accuracy.
The metadocument data can be used to reconstruct the document based only on keystrokes of the author. This reconstructed document can be used to assess the percentage of the document that was generated by the author that was generated not by the keystrokes.
The operating system's active processes can be assessed for suspicious activity. This information can be compared with keystrokes and mouse information to establish the current process and detect searches and queries to LLM programs. The timing of suspicious events allows the comparison of concerning events. If the author made a query to an LLM program and then pasted content into the document, such an action would be suspicious. If that type of action made up a significant portion of the document, then the analysis will return a lower confidence of being authentic.

Each of the analyses noted above can be rated with a score, such as a confidence authenticity score as a percentage. One or more of the scores can be weighted or another statistical adjustment to result in a final score of authenticity.

Some of the variations that are envisioned to the basic concepts are as follows:

Use of the metadocument keystroke and mouse data alone to reconstruct the document. All text can be classified as being generated by the author or external to the application used by the author. The analysis software can indicate all text not generated by the author during the creation of document such as copied material that was erased and retyped thereby not appearing in the final document; and possibly highlighted text generated externally in the analyzed document. Further, the partial reconstructed document that indicates the presence of copied text can be deemed permissible when use of outside copying is allowed. Permission includes, for example, when explicitly quoting other documents; when references are copied from sources such as Google Scholar; and/or when LLM or other text source use is encouraged, such as when used as a tool in creative writing. Optionally, the author can be asked to source those portions of the document generated externally. This can be done before or after applying the analysis software. The analysis software can return a measure, such as a percentage of the document either generated by the author or successfully identified by the author.

Another variation can be using keystroke timing data and/or mouse data to further corroborate human origin. Key cadence and duration can be used to identify whether typing occurs while copying an external document or faster than the speed of thought, that is, how a typical person would process inputting original thought, correct errors, make edits, and other customary actions in creating original content. In cases where a particular author can be evaluated over multiple document creations, the speed of thought can be tuned for that author. For example, an author can generate text off screen such as by an LLM or even copying from an Internet search and manually type the text to attempt to simulate creative material. This can be faster than the speed of thought. However, the recording software can log such actions and the analysis software can report such actions. Further, the key cadence and duration can be used to determine whether the key cadence or other statistics discussed and disclosed herein match a biometric signature of the claimed author of the document, a population of authors, a population for machine-generated content or other suitable statistical analyses. For example, a suitable statistical analysis technique can be used to determine a statistical distance or other “closeness” metric, including but not limited to a total variation distance, a Hellinger distance, a Lévy-Prokhorov metric, a Wasserstein metric, a Kantorovich metric, an earth mover's distance, a Mahalanobis distance, an Amari distance, integral probability metrics that generalize several metrics or pseudometrics on distributions, divergences such as the Kullback-Leibler divergence, the Renyi divergence, the Jensen-Shannon divergence, the Bhattacharyya distance, f-divergence, a discriminability index, a Bayes discriminability index or other suitable statistical analyses techniques. Biometrics generally would not be available for a first-time author, but repeated typing data can be used for adaptive training of the analysis software to accurately detect the identity of the document author. For example, an author may hire someone to retype documents on their computer, but the analysis software can be used to analyze the metadocument for biometrics to determine whether a stated author entered the document in the computer. Further, timing data that is too fast is an indicator that the document is being generated by an LLM.

Another variation is using screen data to likewise corroborate human origin of the document.

Another related variation is using data analytics to indicate a degree of certainty that the document was generated by a human. This variation could include a degree of editing such as a percentage. Typing a document without self-editing is suspect. The analysis software can capture edits made in the document creation. A document will be suspect if there is no or little evidence of editing. This variation can include a measure of typing and use of mouse for creative actions. For example, a percentage could indicate to what degree was the document original and/or to what degree was document not original, such as copied from other sources.

Other and further embodiments utilizing one or more aspects of the inventions described above can be devised without departing from the disclosed invention as defined in the claims. For example, other factors and other variations of factors can be recorded and analyzed. Different forms of reports, including certificates, can be provided and in different methods of delivery. Other variations are contemplated.

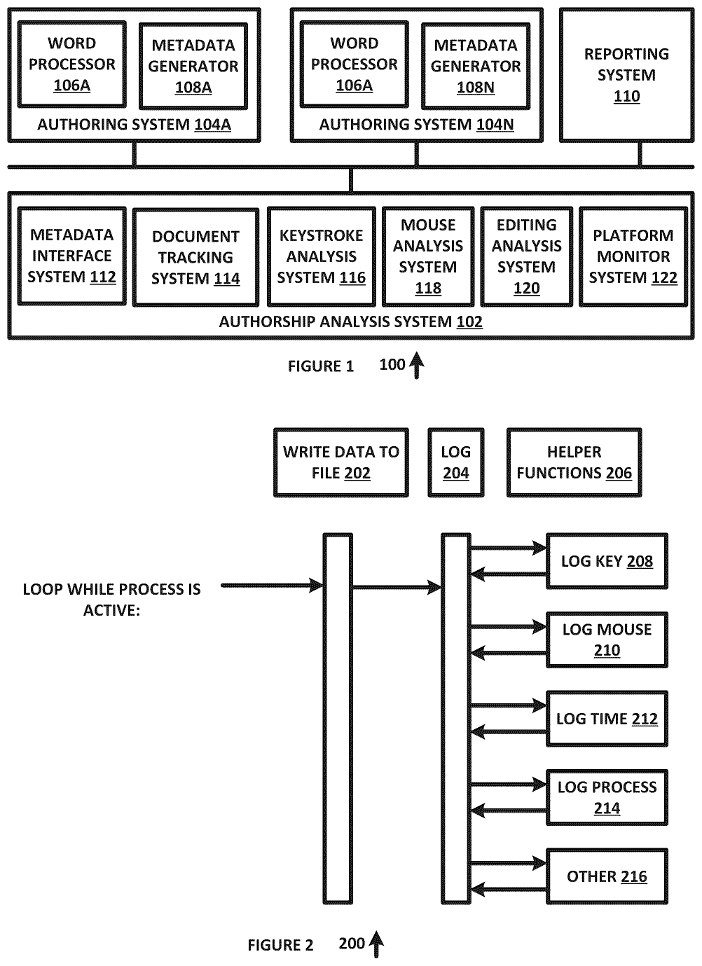

FIG. 1 is a diagram of a system 100 for measuring original content from computers, in accordance with an example embodiment of the present disclosure. System 100 includes authorship analysis system 102, authoring systems 104A-104N, word processors 106A-106N, metadata generators 108A-108N, reporting system 110, metadata interface system 112, document tracking system 114, keystroke analysis system 116, mouse analysis system 118, editing analysis system 120 and platform monitor system 122, each of which can be implemented in hardware or a suitable combination of hardware and software.

Authorship analysis system 102 can be implemented as one or more instructions that are stored in a data memory and loaded into the working memory of a processor that cause the processor to provide document processing functions and to generate log files during document processing. In one example embodiment, authorship analysis system 102 can receive a session initiation request from one of authoring systems 104A-104N and can initiate a document authoring session, such as by downloading a thin client or web browser application to the associated authoring system that supports document processing and log file creation. Other processes disclosed and described herein can also or alternatively be used. Authorship analysis system 102 can be implemented as a cloud service that interfaces with distributed users, as a centralized service that interfaces with users within a defined local area network or in other suitable manners.

Authoring systems 104A-104N can be implemented as one or more instructions that are stored in a data memory and loaded into the working memory of a processor that cause the processor to generate controls that a user can activate to author a document and to monitor the creation of original content in the document. In one example embodiment, the user can initiate a session with authorship analysis system 102 during which the user's actions in creating original content are monitored, to create a log file of actions that can be used to evaluate the content creation process and to detect when content was imported, copied from another source or otherwise not created during the session. Other processes disclosed and described herein can also or alternatively be used. In another example embodiment, authoring systems 104A-104N can include internal monitoring and log generation systems that can function independent of authorship analysis system 102 and without initiation of a session, or in other suitable manners.

Word processors 106A-106N can be implemented as one or more instructions that are stored in a data memory and loaded into the working memory of a processor that cause the processor to provide a word processing environment for creation of content. In one example embodiment, word processors 106A-106N can generate logs of all actions associated with creation of a document, including keystrokes, import of data and other functions. Other processes disclosed and described herein can also or alternatively be used.

Metadata generators 108A-108N can be implemented as one or more instructions that are stored in a data memory and loaded into the working memory of a processor that cause the processor to provide distributed metadata generation, for monitoring actions performed by authors during content creation. In one example embodiment, metadata generators 108A-108N can be implemented as a local thin client or a browser-installed thin client that is initiated during a content generation session and which generates log files of actions taken during the session, included actions external to the use of an associated word processing system, such as web browsing, access to stored files, access to external systems or other actions that can be used to import content during the session. Other processes disclosed and described herein can also or alternatively be used.

Reporting system 110 can be implemented as one or more instructions that are stored in a data memory and loaded into the working memory of a processor that cause the processor to generate a report of metrics for assessing content creation associated with a document. In one example embodiment, reporting system 110 can be accessed by a user and can receive a request from the user to analyze a document, such as to process a log file of metadata and an associated document and to generate metrics that indicate whether the content of the document was independently created or imported into the document from an external source. Other processes disclosed and described herein can also or alternatively be used. Reporting system 110 can interface with authorship analysis system 102 to request analytical processing on demand, to request the results of processing that is performed after a document has been submitted by an author or in other suitable manners.

Metadata interface system 112 can be implemented as one or more instructions that are stored in a data memory and loaded into the working memory of a processor that cause the processor to implement or support metadata generators 108A-108N. In one example embodiment, metadata interface system 112 can interact with metadata generators 108A-108N during content authoring sessions to instantiate metadata interfaces, to receive metadata from authoring platforms and to perform other suitable functions. Other processes disclosed and described herein can also or alternatively be used. The metadata can include log data files generated by word processing systems, log data files generated by web browsers, log data files generated by input-output devices and external memory devices, or other suitable metadata.

Document tracking system 114 can be implemented as one or more instructions that are stored in a data memory and loaded into the working memory of a processor that cause the processor to receive and store document files from authors and to associate the document files with metadata. In one example embodiment, an author can submit a document file at the completion of an authoring session, such as during a timed test session. In another example embodiment, the authorizing system can generate log files while the user is generating content, such as between a session initiation time and a session termination time, and can maintain continuity of the document file between sessions to ensure that the document has not been modified. Other processes disclosed and described herein can also or alternatively be used.

Keystroke analysis system 116 can be implemented as one or more instructions that are stored in a data memory and loaded into the working memory of a processor that cause the processor to analyze keystroke metadata associated with a document file, an author or other suitable keystroke metadata. In one example embodiment, an author can create a profile by generating content in response to predetermined prompts, where the keystroke statistics for the author during the generation of the content are used to create a keystroke profile for the author, such as typing speed, keystroke mistakes and so forth. The keystroke metadata generated during a content creation session can be analyzed to determine whether the keystroke metadata matches the keystroke profile and to generate metrics as a function of the closeness of the match. In one example embodiment, a statistical closeness analysis can be performed to determine whether the statistics data for the author profile matches stored statistical data for the author, for a population, for AI-generated content, or other processes disclosed and described herein can also or alternatively be used.

Mouse analysis system 118 can be implemented as one or more instructions that are stored in a data memory and loaded into the working memory of a processor that cause the processor to analyze mouse metadata associated with a document file, an author or other suitable mouse metadata. In one example embodiment, an author can create a profile by generating content in response to predetermined prompts, where the mouse usage statistics for the author during the generation of the content are used to create a mouse profile for the author, such as movement profiles, mouse control activation profiles and so forth. The mouse metadata generated during a content creation session can be analyzed to determine whether the mouse metadata matches the mouse profile and to generate metrics as a function of the closeness of the match. In one example embodiment, a statistical closeness analysis can be performed to determine whether the statistics data for the author profile matches stored statistical data for the author, for a population, for AI-generated content, or other processes disclosed and described herein can also or alternatively be used.

Editing analysis system 120 can be implemented as one or more instructions that are stored in a data memory and loaded into the working memory of a processor that cause the processor to analyze editing metadata associated with a document file, an author or other suitable editing metadata. In one example embodiment, an author can create a profile by editing content in response to predetermined prompts, where the editing statistics for the author during the generation of the content are used to create an editing profile for the author, such as grammar corrections, spelling corrections and so forth. The editing metadata can generate sections for analysis, such as based on a number of words, a number of paragraphs, a length of time or other suitable metrics to allow internal variations in the log data to be analyzed. Other processes disclosed and described herein can also or alternatively be used. The editing metadata generated during a content creation session can be analyzed to determine whether the editing metadata matches the editing profile and to generate metrics as a function of the closeness of the match. In one example embodiment, a statistical closeness analysis can be performed to determine whether the statistics data for the author profile matches stored statistical data for the author, for a population, for AI-generated content, or other processes disclosed and described herein can also or alternatively be used.

Platform monitor system 122 can be implemented as one or more instructions that are stored in a data memory and loaded into the working memory of a processor that cause the processor to analyze platform metadata gathered during document authoring, such as web pages accessed, local applications accessed or other data that indicates an alternate source for content. Other processes disclosed and described herein can also or alternatively be used. In one example embodiment, platform monitor system 122 can receive web log data, web page cache data, log data generated by metadata generators 108A-108N or other suitable data and can analyze the data to identify activity that could be associated with obtaining content from an alternate source. In one example embodiment, a statistical closeness analysis can be performed to determine whether the statistics data for the author profile matches stored statistical data for the author, for a population, for AI-generated content, or other processes disclosed and described herein can also or alternatively be used.

In operation, system 100 allows users to author content in a manner that can provide indicia of authorship to protect against the use of third-party sources of content. System 100 can thus be used for educational purposes, such as to test students on materials without allowing the students to utilize artificial intelligence tools or copied content to generate responses to test questions. Likewise, system 100 can be used in other applications where authentication of authored content is required.

FIG. 2 is a diagram of a process 200 for generating metrics for assessing original content from computers, in accordance with an example embodiment of the present disclosure. Process 200 can be implemented in hardware or a suitable combination of hardware and software.

Process 200 can include one or more processing loops, such as where a different processing loop is used for different authors or in other suitable manners. Write data to file 202 process can be implemented as one or more instructions that are stored in a data memory and loaded into the working memory of a processor that cause the processor to instantiate the process for each processing loop in response to a session and can be used to monitor the generation of content by an author. Data can be written to one or more log files at predetermined times, for predetermined actions such as selection of the “enter” key or a predetermined “save” command, or in other suitable manners.

Log 204 process can be implemented as one or more instructions that are stored in a data memory and loaded into the working memory of a processor that cause the processor to instantiate the process for each processing loop in response to a session and can be used to log the generation of content by an author. Log 204 can be used by write data to file process 202 to store data to one or more log files at predetermined times, for predetermined actions such as selection of the “enter” key or a predetermined “save” command, or in other suitable manners.

Helper functions 206 processes can be implemented as one or more instructions that are stored in a data memory and loaded into the working memory of a processor that cause the processor to instantiate the helper functions processes for each processing loop in response to a session and can be used to perform logging or other suitable functions. Helper functions can reduce processing load by performing a specific task and can be used to encapsulate repetitive operations into separate units.

Log key 208 process can be implemented as one or more instructions that are stored in a data memory and loaded into the working memory of a processor that cause the processor to instantiate the process for each processing loop in response to a session and can be used to perform logging of keystrokes or other suitable functions. Log key 208 can be configured to log a number of keystrokes, a time of keystrokes or other suitable keystroke data.

Log mouse 210 process can be implemented as one or more instructions that are stored in a data memory and loaded into the working memory of a processor that cause the processor to instantiate the process for each processing loop in response to a session and can be used to perform logging of mouse functions or other suitable functions. Log mouse 210 can be configured to log mouse movements, a time of mouse usage, mouse function controls or other suitable mouse data.

Log time 212 process can be implemented as one or more instructions that are stored in a data memory and loaded into the working memory of a processor that cause the processor to instantiate the process for each processing loop in response to a session and can be used to perform logging of time or other suitable functions. Log time 212 can be configured to log time data or other suitable data, such as for recording the timing of session initiation, session termination or other events that are not associated with other helper functions.

Log process 214 process can be implemented as one or more instructions that are stored in a data memory and loaded into the working memory of a processor that cause the processor to instantiate the process for each processing loop in response to a session and can be used to perform logging of processes that are initiated, processes that are terminated or other suitable functions. Log process 214 can be configured to log processes that are not associated with a word processor or metadata generation, such as web browser processes, thin client usage or other suitable process functions.

Other 216 process can be implemented as one or more instructions that are stored in a data memory and loaded into the working memory of a processor that cause the processor to instantiate the process for each processing loop in response to a session and can be used to perform other suitable functions. Other processes disclosed and described herein can also or alternatively be used.

In operation, process 200 generates metrics for assessing original content from computers. While process 200 is shown with a specific architecture, a person of skill in the art will recognize that process 200 can be implemented using a flow chart, object-oriented programming, a state diagram, a ladder diagram, using other suitable mechanisms or a suitable combination of mechanisms.

FIG. 3 is a diagram of a process 300 for generating a confidence metric, in accordance with an example embodiment of the present disclosure. Process 300 can be implemented in hardware or a suitable combination of hardware and software.

Process 300 begins at 302 where a session certificate is generated. The session certificate can be used by authoring processes, such as to generate log data or for other suitable purposes.

Process 300 also includes generation of a final artifact at 304. In one example embodiment, the final artifact can be generated when a word document is submitted for analysis in combination with log data and other suitable data and metadata.

At 306, the confidence analysis starts, such as when a user requests an analysis of the final artifact, at periodic times as part of batch processing or in other suitable manners. Process 300 proceed to 308, where it is determined whether a keystroke rate is greater than a threshold. In one example embodiment, the keystroke rate can be determined when a user profile is generated and stored in the user profile for use in generating a confidence analysis metric, such as to detect when a different user is generating the content in a remote location where the identity of the user cannot be otherwise authenticated.

If it is determined that the keystroke rate is greater than the threshold at 308, the process proceeds to 320 and the determination is provided as input to AI confidence analysis. Otherwise, the process proceeds to 316 for key stroke user identification, such as to confirm that the keystroke rate associated with the final artifact correlates to the user's profile. In addition, other suitable processes can also or alternatively be performed, such as to analyze the timing of keystrokes, keystroke patterns or other suitable keystroke data. The keystroke user identification analysis data is provided at 320 as input to AI confidence analysis.

Process 300 also proceeds in parallel to 310 where symbol error rate analysis is performed. In one example embodiment, profile data that identifies symbol error rates associated with a user can be generated and stored, such as a common keystroke error or other suitable symbol errors. The profile symbol error rate can be compared to the artifact symbol error rate and can be used to generate a metric that is provided at 320 as input to AI confidence analysis.

Process 300 also proceeds in parallel to 312 where reconstruct and compare analysis is performed. In one example embodiment, log data can be used to reconstruct a document that can be compared to the final artifact, or other suitable processes can also or alternatively be used. The output of the reconstruct and compare analysis can be used to generate a metric that is provided at 320 as input to AI confidence analysis.

Process 300 also proceeds in parallel to 314 where session progress information analysis is performed. In one example embodiment, session progress data can be analyzed and compared to profile data, or other suitable processes can also or alternatively be used. The output of the session progress information analysis can be used to generate a metric that is provided at 320 as input to AI confidence analysis.

At 318, timestamp analysis is performed in conjunction with the results of reconstruct and compare analysis and session progress information analysis. In one example embodiment, timestamp data can be used to analyze the output of the reconstruct and compare analysis and session progress information analysis, timestamp data can be used as a component of the reconstruct and compare analysis and session progress information analysis or other suitable processes can also or alternatively be used. The output of the timestamp analysis can be used to generate a metric that is provided at 320 as input to AI confidence analysis.

At 320, AI confidence analysis is performed by analyzing the keystroke rate data, the keystroke user identification data, the symbol error rate data, the reconstruct and compare data, the session progress information data and the time stamp analysis data. In one example embodiment, a confidence estimate can be separately generated based on each of the keystroke rate data, the keystroke user identification data, the symbol error rate data, the reconstruct and compare data, the session progress information data and the time stamp analysis data and the confidence estimates can be combined, averaged or otherwise separately us to generate an output. In another example embodiment, the output can be generated using multiple dependent functions, such as where the keystroke user identification is used as an input to the analysis of symbol error rate, on a section-by-section basis for a plurality of sections within the document, or in other suitable manners.

In operation, process 300 generates a confidence metric for assessing original content from computers. While process 300 is shown with a specific architecture, a person of skill in the art will recognize that process 300 can be implemented using a flow chart, object-oriented programming, a state diagram, a ladder diagram, using other suitable mechanisms or a suitable combination of mechanisms.

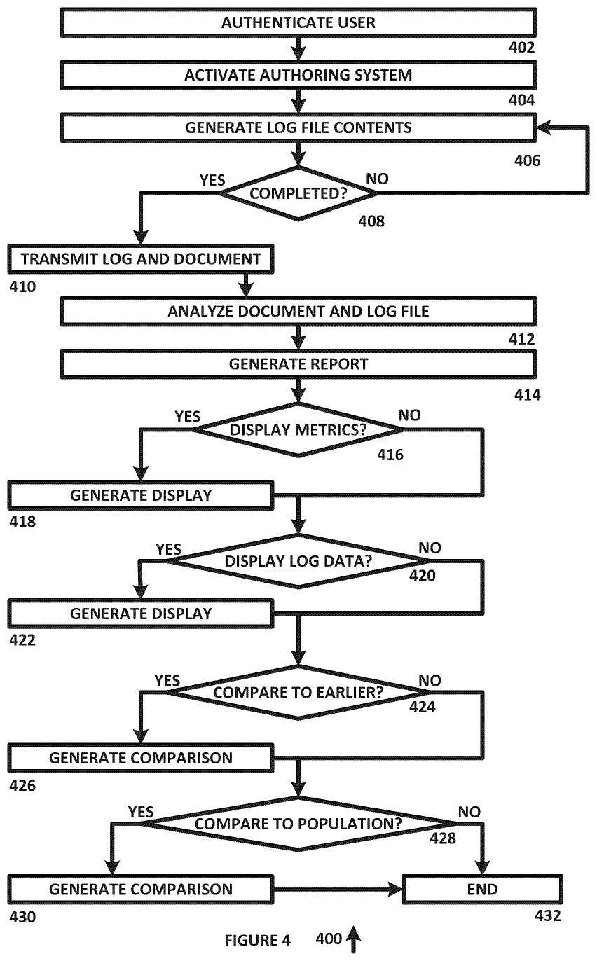

FIG. 4 is a diagram of an algorithm 400 for analyzing a document to generate a confidence estimate, in accordance with an example embodiment of the present disclosure. Algorithm 400 can be implemented in hardware or a suitable combination of hardware and software.

Algorithm 400 begins at 402, where a user is authenticated. In one example embodiment, a user can be authenticated when they log onto a server or in other suitable manners, and a certificate or other suitable data structures can be generated to provide continuous authentication of the user during document creation. The algorithm then proceeds to 404.

At 404, the authoring system is authenticated. In one example embodiment, the authoring system components can be verified to confirm that they are associated with a specific user platform, a thin client can be instantiated or other suitable processes can also or alternatively be used. The algorithm then proceeds to 406.

At 406, log file contents are generated while the user drafts content for a document. In one example embodiment, one or more log files can be generated during document authoring, as discussed and described further herein. The algorithm then proceeds to 408.

At 408, it is determined whether the document has been completed. If so, the algorithm proceeds to 410, otherwise the algorithm returns to 406.

At 410, the log files and document are transmitted to an analysis system. In one example embodiment, the author can activate a control that sends a final submission version of a document and an associated log file to a server for processing, or other suitable processes can also or alternatively be used. The algorithm then proceeds to 412.

At 412, the document and log file are analyzed. In one example embodiment, a server-based analysis system can be used to analyze the document file and log file and to generate preliminary pass/fail data or other suitable metrics as disclosed and discussed further herein. The algorithm then proceeds to 414.

At 414, a report is generated. In one example embodiment, a suitable initial report is generated and additional analysis can be performed for documents where the confidence metric is lower than a predetermined threshold or other suitable processes can also or alternatively be used. The algorithm then proceeds to 416.

At 416, it is determined whether to display metrics. In one example embodiment, the teacher of a course who is reviewing essays, essay tests or other documents from students can select metrics for closer scrutiny, such as if a score is close to a threshold, if a warning indicator is generated, or so forth. If it is determined that metrics should be displayed, the algorithm proceeds to 418, otherwise it proceeds to 420.

At 418, a display with additional metrics is generated. In one example embodiment, the display metrics can include keystroke data, mouse data, data indicating which content may have been imported, web sites that were looked at while the document was being prepared or other suitable data. The display function can allow the reviewer to see metrics as a function of each of a plurality of sections of the document, such as to see keystroke data for each section, mouse data for each section and so forth, to determine whether significant or notable variations occurred in some of the sections. The algorithm then proceeds to 420.

At 420, it is determined whether to display log data. In one example embodiment, a teacher can elect to display log data, such as to review temporal associations between keystrokes, mouse, cut and paste activity, website browsing activity or other suitable log data. If it is determined that log data is to be displayed, the algorithm proceeds to 422, otherwise the algorithm proceeds to 424.

At 422, a log data display is generated. In one example embodiment, the log data can be displayed as selected, in sections, as a group or in other suitable manners. The algorithm then proceeds to 424.

At 424, it is determined whether to compare the metadata for the current document to metadata from earlier documents. If it is determined that a comparison should be generated, the algorithm proceeds to 426, otherwise the algorithm proceeds to 428.

At 426, a comparison display is generated. In one example embodiment, a teacher can compare the metrics or metadata for a submitted document to sections within the document, to the metrics and metadata for earlier documents authored by the user, or to other suitable data, to look for similarities and differences or for other suitable purposes. The algorithm then proceeds to 428.

At 428, it is determined whether to compare the metadata and other metrics to metadata and metrics for a selected population or content creators, such as for other classmates that year, students from an earlier year or a different class and so forth. If it is determined that the comparison should be generated the algorithm proceeds to 430, otherwise it proceeds to 432 and ends.

At 430, the comparison is generated. In one example embodiment, the teacher can compare the metrics for this document to documents authored by others. The algorithm then proceeds to 432 and terminates.

In operation, algorithm 400 analyzes a document to generate a confidence metric. While algorithm 400 is shown as a flow chart, a person of skill in the art will recognize that algorithm 400 can be implemented using object-oriented programming, a state diagram, a ladder diagram, using other suitable mechanisms or a suitable combination of mechanisms.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intend to protect fully all such modifications and improvements that come within the scope of the following claims.

What is claimed is:

1. A method of for analyzing text data, comprising:
detecting a plurality of actions of an author during creation of a document data file;
generating a metadata log data file of the plurality of actions;
analyzing the metadata log data file to identify one or more actions that fall outside of an authorized action profile; and
generating a report that identifies the one or more actions.

2. The method of claim 1, wherein the plurality of actions comprise at least two of the following: keystroke timing, keystroke cycling, keystroke errors, keystroke corrections, mouse clicking, mouse movement, touch screen input, accessing external material, copying external material, accessing preexisting audio screen data, accessing preexisting data, playing preexisting audio, playing captured video, playing captured audio data, speaking audio that is configured to be translated into text and speaking audio that can be used to establish speaker identity.

3. The method of claim 1, wherein the report comprises certificate indicating author originality of the document.

4. The method of claim 1, further comprising providing a measure of at least one of original data of the author and non-original data of the author.

5. The method of claim 1, further comprising providing a measure of data generated directly by the author.

6. The method of claim 1, further comprising providing a measure of data externally accessed during creation of the document whether such data appears in the analyzed document.

7. The method of claim 1, further comprising providing an option for the author to stipulate use for non-original data in the document.

8. The method of claim 1, wherein analyzing the record comprises weighting at least of the actions in providing the report.

9. A system for determining original content in a document, comprising:
a word processing system operating on a first data processor that configures the data processor to generate a document file in response to a user input;
a metadata generator operating on the first data processor that configures the data processor to generate a log file containing a plurality of metadata at a plurality of points during the generation of the document file; and
a metadata analysis system operating on a second processor remote from the first processor that configures the second processor to receive the document file and the metadata file and to analyze the document file using the metadata file to generate an authorship authentication metric that identifies whether the document file was generated by a specific user.

10. The system of claim 9 wherein the metadata analysis system further comprises a keystroke analysis system operating on the second processor that configures the second processor to extract keystroke metadata from the metadata file and to analyze the keystroke metadata to determine whether it exceeds a threshold.

11. The system of claim 9 wherein the metadata analysis system further comprises a mouse analysis system operating on the second processor that configures the second processor to extract mouse metadata from the metadata file and to analyze the mouse metadata to determine whether it exceeds a threshold.

12. The system of claim 9 wherein the metadata analysis system further comprises an editing analysis system operating on the second processor that configures the second processor to extract editing metadata from the metadata file and to analyze the editing metadata to determine whether it exceeds a threshold.

13. The system of claim 9 wherein the metadata analysis system further comprises a platform monitor system operating on the second processor that configures the second processor to extract platform metadata from the metadata file and to analyze the platform metadata to determine whether it exceeds a threshold.

14. The system of claim 9 wherein the metadata analysis system further comprises a keystroke analysis system operating on the second processor that configures the second processor to extract keystroke metadata from the metadata file and to analyze the keystroke metadata to determine whether keystroke statistics match stored keystroke statistics.

15. The system of claim 9 wherein the metadata analysis system further comprises a mouse analysis system operating on the second processor that configures the second processor to extract mouse metadata from the metadata file and to analyze the mouse metadata to determine whether mouse movement statistics match stored mouse movement statistics.

16. The system of claim 9 wherein the metadata analysis system further comprises an editing analysis system operating on the second processor that configures the second processor to extract editing metadata from the metadata file and to analyze the editing metadata to determine whether editing statistics match stored editing statistics.

17. The system of claim 9 wherein the metadata analysis system further comprises a platform monitor system operating on the second processor that configures the second processor to extract platform metadata from the metadata file and to analyze the platform metadata to determine whether platform statistics match stored platform statistics.
